(19) United States
(12) Patent Application Publication
(10) Pub. No.: US 2024/0340687 A1
(43) Pub. Date: Oct. 10, 2024

(54) Dynamic and QOS bandwidth aware load balancing in multi-path software defined wan area networks

(71) Applicant: Cisco Technology, Inc., San Jose, CA (US)

(72) Inventors: Tony Shen, Shanghai (CN); Hongbo Xia, Shanghai (CN); Alan Xiao-rong Wang, Shanghai (CN); Yin Wang, Shanghai (CN)

(21) Appl. No.: 18/358,719

(22) Filed: Jul. 25, 2023

Related U.S. Application Data
(60) Provisional application No. 63/495,010, filed on Apr. 7, 2023.

(51) Int. Cl. H04W 28/02; H04W 28/08

(52) U.S. Cl. CPC H04W 28/0268; H04W 28/0284; H04W 28/0967

(57) ABSTRACT

Aspects of the present disclosure are directed to dynamic adjustment of load-balancing weights across multiple network transport interfaces in a network, informed in part by Quality of Service (QoS) metrics. In one aspect, a method includes determining one or more metrics based on one or more Software-defined Wide Area Network (SDWAN) session level throughput and SDWAN session loss through one or more tunnels; generating a Quality of Service (QoS) SDWAN session level shape rate per tunnel based on the one or more metrics; and dynamically adjusting an SDWAN forwarding load-balance weight for each of the one or more tunnels based on the QoS SDWAN session level shape rate.

### RELATED APPLICATION DATA

This application claims priority to U.S. Provisional Application No. 63/495,010 filed on Apr. 7, 2023, the entire content of which is incorporated herein by reference.

### TECHNICAL FIELD

The present disclosure generally relates to adjusting bandwidth in a computer network, and more specifically to dynamic adjustment of load-balancing weights across multiple network transport interfaces in a network, informed in part by Quality of Service (QoS) metrics.

### BACKGROUND

A computer network may refer to a group of computing components (e.g. gateways, routers, end devices, etc.) that communicate over network connections. Computer networks may support many applications and services. As an example, computer networks may support cloud-based services, such as software-as-a-service and infrastructure-as-a-service services.

Within networks, load-Balance across multiple head-ends is deployed at customer networks. The load-balancing is intended to maximize available bandwidth usage in the network.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture, according to some aspects of the present disclosure;

FIG. 2 illustrates an example of a network topology, according to some aspects of the present disclosure;

FIG. 3 illustrates an example of a diagram showing the operation of a protocol for managing an overlay network, according to some aspects of the present disclosure;

FIG. 4A illustrates an example multi-hub deployment, according to some aspects of the present disclosure;

FIG. 4B illustrates an example of a deployment with TLOC extension, according to some aspects of the present disclosure;

FIG. 5 shows an example table for SDWAN forwarding load-balance with static weight, according to some aspects of the present disclosure;

FIG. 6 illustrates a simplified deployment in which dynamically weighted load-balancing informed in part by adaptive QoS parameters may be deployed, according to some aspects of the present disclosure;

FIG. 7 visually illustrates the steps of dynamically weighted load-balancing informed in part by adaptive QoS parameters, according to some aspects of the present disclosure;

FIG. 8 illustrates an example SDWAN forwarding load-balance table with dynamic weights, according to some aspects of the present disclosure;

FIG. 9 illustrates an example method of dynamically weighted load-balancing informed in part by adaptive QoS parameters, according to some aspects of the present disclosure; and

FIG. 10 shows an example of computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to dynamic adjustment of traffic load-balancing weights across multiple interfaces in a network based in part on adaptive Quality of Service (QoS) metrics. This QoS-based dynamic load-balancing can prevent local QoS traffic overrun and uneven traffic load-balancing across multiple transport interfaces in a network. Instead of dropping traffic when exceeding local shaper bandwidth capacity, the proposed dynamic weighted load-balance mechanism can split exceeding network traffic over alternative Wide Area Network (WAN), and dynamic weighted load-balancing flows based on real-time transport bandwidth capacity and utilization. By combining Adaptive QoS Path Monitor and Software Defined WAN (SDWAN) Weighted Forwarding module, an SDWAN router (e.g., a cEdge) can provide more advanced capability for traffic engineering and maximize multi-path available bandwidth usage.

In one aspect, a method includes determining one or more metrics based on one or more Software-defined Wide Area Network (SDWAN) session level throughput and SDWAN session loss through one or more tunnels; generating a Quality of Service (QoS) SDWAN session level shape rate per tunnel based on the one or more metrics; and dynamically adjusting an SDWAN forwarding load-balance weight for each of the one or more tunnels based on the QoS SDWAN session level shape rate.

In another aspect, the method further includes verifying the one or more metrics at a subsequent time after adjusting the SDWAN session level shape rate and the SDWAN forwarding load-balance weight; and based on a change of the one or more metrics, further adjusting the SDWAN session level shape rate and the SDWAN forwarding load-balance weight in real-time.

In another aspect, the method further includes determining that a first transport link has local Wide Area Network (WAN) QoS congestion based on the one or more metrics monitored by a path monitor service, the first transport link having a first weight; determining that a second transport link is underutilized based on the one or more metrics monitored by the path monitor service, the second transport link having a second weight; dynamically adjusting the SDWAN forwarding load-balance weight for the first transport link and the second transport link by modifying the first weight and the second weight in accordance with the one or more metrics monitored by the path monitor service; and rerouting traffic from the first transport link to the second transport link based on QoS requirements.

In another aspect, the method further includes determining, at a first time, a first utilization of a first transport link and a second utilization of a second transport link based on the one or more metrics monitored by a path monitor service, wherein at least one of the first transport link and the second transport link is a dynamic link with variable transport bandwidth capacity; dynamically assigning a first weight for the first transport link and a second weight for the second transport link; determining, at a second time, that a transport bandwidth capacity of the second transport link has increased; based on the determination, dynamically increasing the second weight and decreasing the first weight; and routing traffic along the first transport link in accordance with the first weight and the second transport link in accordance with the second weight.

In another aspect, the method further includes adjusting the SDWAN forwarding load-balance weight for each of the one or more tunnels by a Transport Locator (TLOC) Session weight value, the TLOC session weight value based on the one or more metrics describing measured bandwidth capacity; and forwarding the TLOC session weight value to a SDWAN TLOC forwarding hashing table which dynamically distributes and load balances traffic flows over multiple tunnels based on available bandwidth.

In another aspect, a path monitor service leverages multiple tunnel bandwidth usage and local WAN loss ratio.

In another aspect, a path monitor service monitors QoS status for each of the one or more tunnels by monitoring traffic throughput, Local/WAN drop ratio, and congestion state.

In one aspect, a network controller includes one or more memories having computer-readable instructions stored therein, and one or more processors. The one or more processors are configured to execute the computer-readable instructions to determine one or more metrics based on one or more Software-defined Wide Area Network (SDWAN) session level throughput and SDWAN session loss through one or more tunnels; generate a Quality of Service (QoS) SDWAN session level shape rate per tunnel based on the one or more metrics; and dynamically adjust an SDWAN forwarding load-balance weight for each of the one or more tunnels based on the QoS SDWAN session level shape rate.

In one aspect, one or more non-transitory computer readable media include computer-readable instructions, which when executed by a network controller, cause the network controller to determine one or more metrics based on one or more Software-defined Wide Area Network (SDWAN) session level throughput and SDWAN session loss through one or more tunnels; generate a Quality of Service (QoS) SDWAN session level shape rate per tunnel based on the one or more metrics; and dynamically adjust an SDWAN forwarding load-balance weight for each of the one or more tunnels based on the QoS SDWAN session level shape rate.

### Example Embodiments

Legacy WAN architectures are facing major challenges under this evolving landscape. Legacy WAN architectures typically consist of multiple MPLS transports, or an MPLS paired with an Internet or LTE used in an active/backup fashion, most often with Internet or software-as-a-service (SaaS) traffic being backhauled to a central data center or regional hub for Internet access. Issues with these architectures include insufficient bandwidth along with high bandwidth costs, application downtime, poor SaaS performance, complex operations, complex workflows for cloud connectivity, long deployment times and policy changes, limited application visibility, and difficulty in securing the network.

SDWAN is part of a broader technology of software-defined networking (SDN). SDN is a centralized approach to network management which abstracts away the underlying network infrastructure from its applications. This de-coupling of data plane forwarding and control plane allows you to centralize the intelligence of the network and allows for more network automation, operations simplification, and centralized provisioning, monitoring, and troubleshooting. SDWAN applies these principles of SDN to the WAN.

Cisco® SDWAN solution is an enterprise-grade WAN architecture overlay that enables digital and cloud transformation for enterprises. Cisco® SDWAN integrates routing, security, centralized policy, and orchestration into large-scale networks. It is multitenant, cloud-delivered, highly automated, secure, scalable, and application-aware with rich analytics. Cisco SD-WAN technology addresses the problems and challenges of common WAN deployments.

SDWAN forwarding and adaptive QoS (per-link adaptive QoS) are currently implemented independently such that per-link adaptive QoS parameters do not inform any decision-making process for load-balancing network traffic and SDWAN forwarding process. The present disclosure bridges the gap between these two processes to ensure that in a multi-hop setting with multiple interfaces, unused bandwidth on different links are used while ensuring that QoS parameters associated with any network traffic are met.

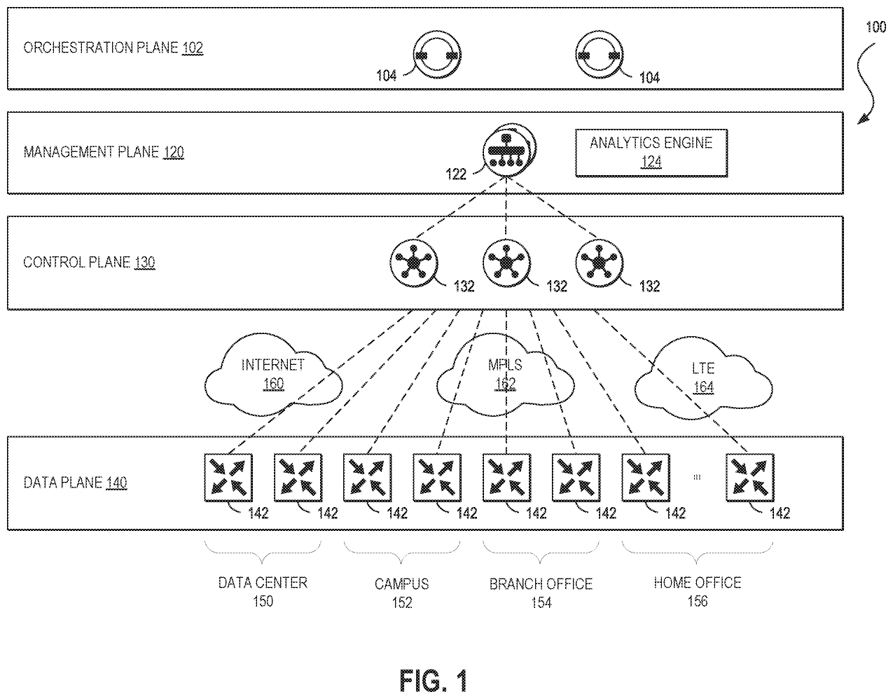

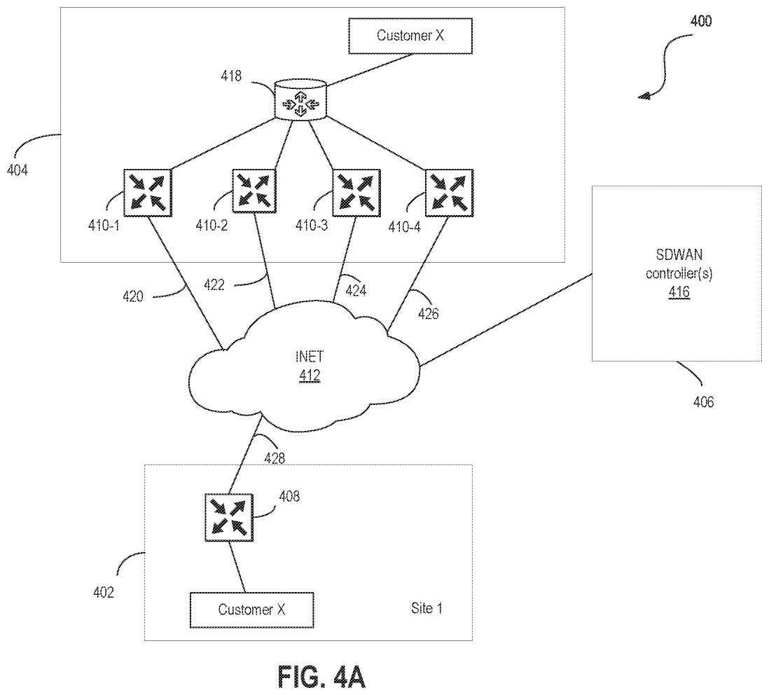

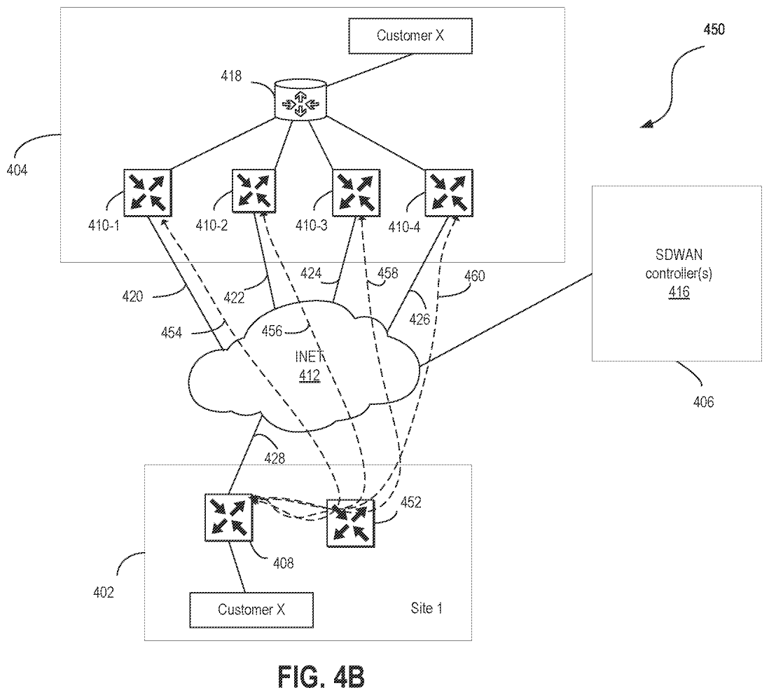

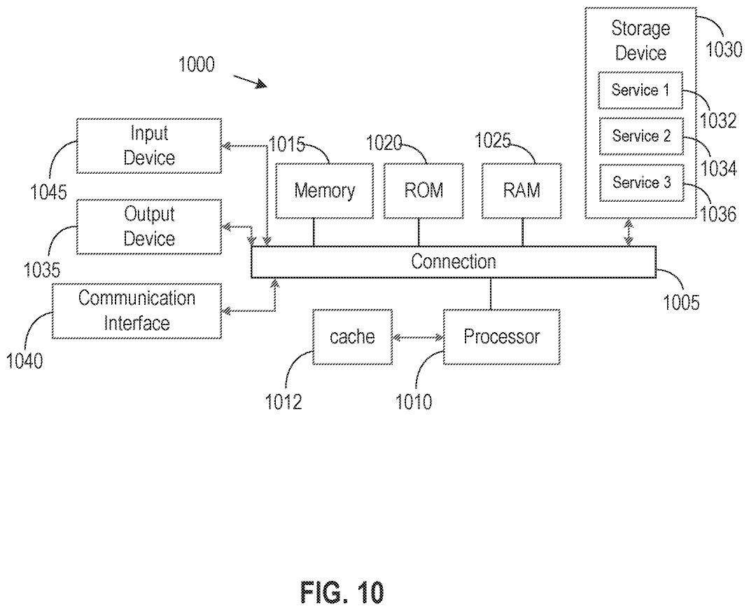

The disclosure begins with a description of example architectures of an SDWAN network, an example network topology, and an example overlay network with respect to FIGS. 1, 2, and 3, respectively. Example embodiments of adaptive weighted load-balancing based in part on adaptive QoS parameters are then described with reference to FIGS. 4-9. The disclosure concludes with example network and device architectures with reference to FIG. 10.

FIG. 1 illustrates an example of a high-level network architecture, according to some aspects of the present disclosure. Network architecture 100 may be an example of Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 120, a control plane 130, and a data plane 140. The orchestration plane 102 CAN assist in the automatic on-boarding of edge network devices 142 (e.g., switches, routers, etc.) in an overlay network. The orchestration plane 102 can include one or more physical or virtual network orchestrator appliances 104. The network orchestrator appliance(s) 104 can perform the initial authentication of the edge network devices 142 and orchestrate connectivity between devices of the control plane 130 and the data plane 140. In some embodiments, the network orchestrator appliance(s) 104 can also enable communication of devices located behind Network Address Translation (NAT). In some embodiments, physical or virtual Cisco® SD-WAN vBond appliances can operate as the network orchestrator appliance(s) 104.

The management plane 120 can be responsible for central configuration and monitoring of a network. The management plane 120 can include analytics engine 124 and one or more physical or virtual network management appliances 122. In some embodiments, the network management appliance(s) 122 can provide centralized management of the network via a graphical user interface to enable a user to monitor, configure, and maintain the edge network devices 142 and links (e.g., Internet transport network 160, MPLS network 162, 4G/LTE network 164) in an underlay and overlay network. The network management appliance(s) 122 can support multi-tenancy and enable centralized management of logically isolated networks associated with different entities (e.g., enterprises, divisions within enterprises, groups within divisions, etc.). Alternatively or in addition, the network management appliance(s) 122 can be a dedicated network management system for a single entity. In some embodiments, physical or virtual Cisco® SD-WAN vManage appliances can operate as the network management appliance(s) 122.

The control plane 130 can build and maintain a network topology and make decisions on where traffic flows. The control plane 130 can include one or more physical or virtual network controller appliance(s) 132. The network controller appliance(s) 132 can establish secure connections to each network device 142 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network controller appliance(s) 132 can operate as route reflectors. The network controller appliance(s) 132 can also orchestrate secure connectivity in the data plane 140 between and among the edge network devices 142. For example, in some embodiments, the network controller appliance(s) 132 can distribute crypto key information among the network device(s) 142. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network controller appliance(s) 132.

The data plane 140 can be responsible for forwarding packets based on decisions from the control plane 130. The data plane 140 can include the edge network devices 142, which can be physical or virtual network devices. The edge network devices 142 can operate at the edges various network environments of an organization, such as in one or more data centers or colocation centers 150, campus networks 152, branch office networks 154, home office networks 154, and so forth, or in the cloud (e.g., Infrastructure as a Service (IaaS), Platform as a Service (PaaS), SaaS, and other cloud service provider networks). The edge network devices 142 can provide secure data plane connectivity among sites over one or more WAN transports, such as via one or more Internet transport networks 160 (e.g., Digital Subscriber Line (DSL), cable, etc.), MPLS networks 162 (or other private packet-switched network (e.g., Metro Ethernet, Frame Relay, Asynchronous Transfer Mode (ATM), etc.), mobile networks 164 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 142 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 142.

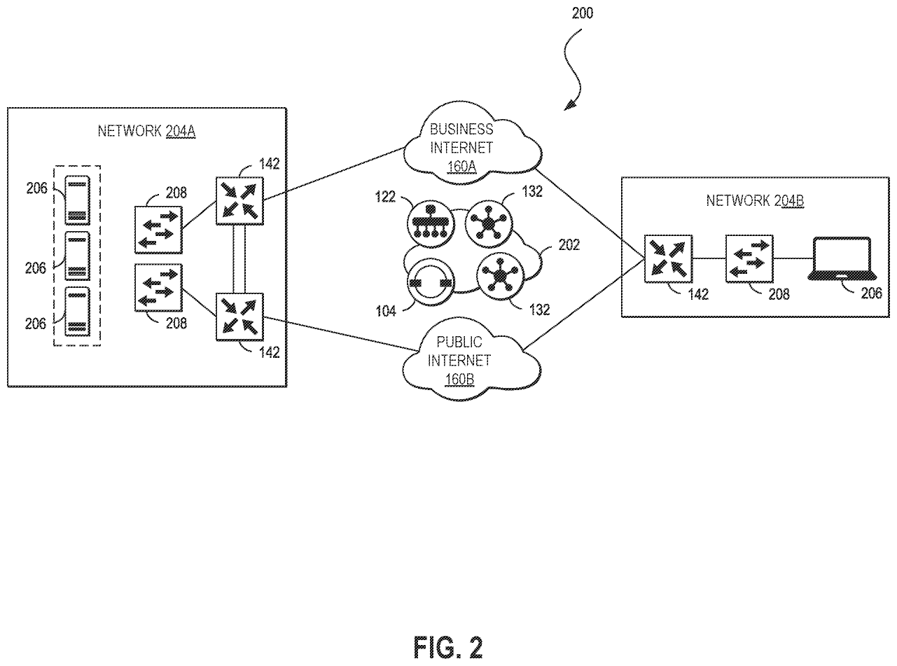

FIG. 2 illustrates an example of a network topology, according to some aspects of the present disclosure. Example network topology 200 shows various aspects of the network architecture 100. The network topology 200 can include a management network 202, a pair of network sites 204A and 204B (collectively, 204) (e.g., the data center(s) 150, the campus network(s) 152, the branch office network(s) 154, the home office network(s) 156, cloud service provider network(s), etc.), and a pair of Internet transport networks 160A and 160B (collectively, 160). The management network 202 can include one or more network orchestrator appliances 104, one or more network management appliance 122, and one or more network controller appliances 132. Although the management network 202 is shown as a single network in this example, one of ordinary skill in the art will understand that each element of the management network 202 can be distributed across any number of networks and/or be co-located with the sites 204. In this example, each element of the management network 202 can be reached through either transport network 160A or 160B.

Each site can include one or more endpoints 206 connected to one or more site network devices 208. The endpoints 206 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 206 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

The site network devices 208 can include physical or virtual switches, routers, and other network devices. Although the site 204A is shown including a pair of site network devices and the site 204B is shown including a single site network device in this example, the site network devices 208 can comprise any number of network devices in any network topology, including multi-tier (e.g., core, distribution, and access tiers), spine-and-leaf, mesh, tree, bus, hub and spoke, and so forth. For example, in some embodiments, one or more data center networks may implement the Cisco® Application Centric Infrastructure (ACI) architecture and/or one or more campus networks may implement the Cisco® Software Defined Access (SD-Access or SDA) architecture. The site network devices 208 can connect the endpoints 206 to one or more edge network devices 142, and the edge network devices 142 can be used to directly connect to the transport networks 160.

In some embodiments, “color” can be used to identify an individual WAN transport network, and different WAN transport networks may be assigned different colors (e.g., mpls, private1, biz-internet, metro-ethernet, lte, etc.). In this example, the network topology 200 can utilize a color called “biz-internet” for the Internet transport network 160A and a color called “public-internet” for the Internet transport network 160B.

In some embodiments, each edge network device 208 can form a Datagram Transport Layer Security (DTLS) or TLS control connection to the network controller appliance(s) 132 and connect to any network control appliance 132 over each transport network 160. In some embodiments, the edge network devices 142 can also securely connect to edge network devices in other sites via IPSec tunnels. In some embodiments, the BFD protocol may be used within each of these tunnels to detect loss, latency, jitter, and path failures.

On the edge network devices 142, color can be used help to identify or distinguish an individual WAN transport tunnel (e.g., no same color may be used twice on a single edge network device). Colors by themselves can also have significance. For example, the colors metro-ethernet, mpls, and private1, private2, private3, private4, private5, and private6 may be considered private colors, which can be used for private networks or in places where there is no NAT addressing of the transport IP endpoints (e.g., because there may be no NAT between two endpoints of the same color). When the edge network devices 142 use a private color, they may attempt to build IPSec tunnels to other edge network devices using native, private, underlay IP addresses. The public colors can include 3g, biz, internet, blue, bronze, custom1, custom2, custom3, default, gold, green, lte, public-internet, red, and silver. The public colors may be used by the edge network devices 142 to build tunnels to post-NAT IP addresses (if there is NAT involved). If the edge network devices 142 use private colors and need NAT to communicate to other private colors, the carrier setting in the configuration can dictate whether the edge network devices 142 use private or public IP addresses. Using this setting, two private colors can establish a session when one or both are using NAT.

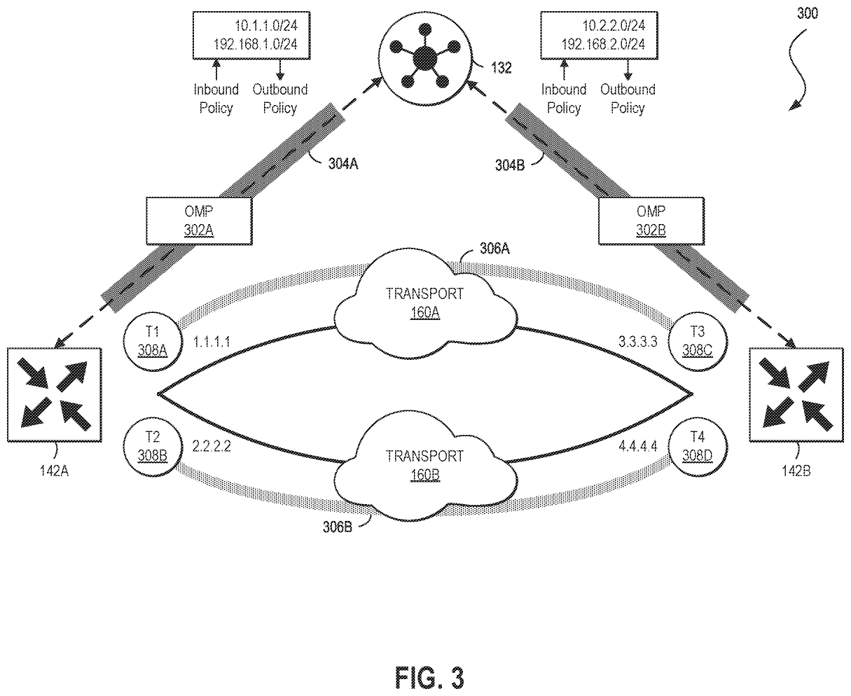

FIG. 3 illustrates an example of a diagram showing the operation of a protocol for managing an overlay network, according to some aspects of the present disclosure. Example diagram 300 shows the operation of OMP, which may be used in some embodiments to manage an overlay of a network (e.g., the network architecture 100). In this example, OMP messages 302A and 302B (collectively, 302) may be transmitted back and forth between the network controller appliance 132 and the edge network devices 142A and 142B, respectively, where control plane information, such as route prefixes, next-hop routes, crypto keys, policy information, and so forth, can be exchanged over respective secure DTLS or TLS connections 304A and 304B. The network controller appliance 132 can operate similarly to a route reflector. For example, the network controller appliance 132 can receive routes from the edge network devices 142, process and apply any policies to them, and advertise routes to other edge network devices 142 in the overlay. If there is no policy defined, the edge network devices 142 may behave in a manner similar to a full mesh topology, where each edge network device 142 can connect directly to another edge network device 142 at another site and receive full routing information from each site.

OMP can advertise three types of routes:
OMP routes, which can correspond to prefixes that are learned from the local site, or service side, of the edge network device 142. The prefixes can be originated as static or connected routes, or from within, for example, the OSPF or BGP protocols, and redistributed into OMP so they can be carried across the overlay. OMP routes can advertise attributes such as transport location (TLOC) information (which can similar to a BGP next-hop IP address) and other attributes such as origin, originator, preference, site identifier, tag, and virtual private network (VPN). An OMP route may be installed in the forwarding table if the TLOC to which it points is active.
TLOC routes, which can correspond to logical tunnel termination points on the edge network devices 142 that connect into the transport networks 160. In some embodiments, a TLOC route can be uniquely identified and represented by a three-tuple, including an IP address, link color, and encapsulation (e.g., Generic Routing Encapsulation (GRE), IPSec, etc.). In addition to system IP address, color, and encapsulation, TLOC routes can also carry attributes such as TLOC private and public IP addresses, carrier, preference, site identifier, tag, and weight. In some embodiments, a TLOC may be in an active state on a particular edge network device 142 when an active BFD session is associated with that TLOC.
Service routes, which can represent services (e.g., firewall, distributed denial of service (DDoS) mitigator, load balancer, intrusion prevent system (IPS), intrusion detection systems (IDS), WAN optimizer, etc.) that may be connected to the local sites of the edge network devices 142 and accessible to other sites for use with service insertion. In addition, these routes can also include VPNs; the VPN labels can be sent in an update type to tell the network controller appliance 132 what VPNs are serviced at a remote site.

In the example of FIG. 3, OMP is shown running over the DTLS/TLS tunnels 304 established between the edge network devices 142 and the network controller appliance 132. In addition, the diagram 300 shows an IPSec tunnel 306A established between TLOC 308A and 308C over the WAN transport network 160A and an IPSec tunnel 306B established between TLOC 308B and TLOC 308D over the WAN transport network 160B. Once the IPSec tunnels 306A and 306B are established, BFD can be enabled across each of them.

As noted above, SDWAN forwarding and adaptive QoS (per-link adaptive QoS) are currently implemented independently such that per-link adaptive QoS parameters do not inform any decision-making process for load-balancing network traffic and SDWAN forwarding process. The present disclosure bridges the gap between these two processes to ensure that in a multi-hop setting with multiple interfaces, unused bandwidth on different links are used while ensuring that QoS parameters associated with any network traffic are met.

The issue being addressed by the proposed adaptive weighted load-balancing based on QoS parameters will be described with reference to FIG. 4 below.

FIG. 4A illustrates an example multi-hub deployment, according to some aspects of the present disclosure. Example deployment 400 shows a branch site 402, a data center 404, and an SDWAN management network 406.

Branch site 402 can include one or more branch edge router 408 (hereinafter, may be referred to as spoke 408). The number of branch edge routers are not limited to that shown in FIG. 4A. Branch site 402 may also be referred to as Site 1 for customer X. Branch site 402 can be a satellite office, a retail location, an office of a particular corporation etc.

Data center 404 may include one or more edge routers such as edge routers 410-1, 410-2, 410-3, and 410-4 (hereinafter, may be referred to as hubs 410). Each of hubs 410 may connect with one or more of spokes 408 via one or more networks 412 to provide network services to branch site 02. Data center 404 may also include a transport gateway 418 for customer X.

SD-WAN management network 406 can create and manage software defined network connections 414 over network 412 to connect hubs 410 and spoke 408. SD-WAN management network 112 can include any number of SD-WAN controllers 416, which can be the same as network controller appliances 132 of FIG. 1 (e.g., can be an SDWAN vManage, vBond, vSmart, etc.).

Each of spoke 408 and hubs 410 may also be referred to as a cEdge.

In example deployment 400, there is a single SDWAN transport to branch site 402 with a particular link capacity (e.g., 400 Mbps). This tunnel is shown as link 428 in FIG. 4A. Given the capacity of 400 Mbps, network traffic from hubs 410 to spoke 408 may be load balanced among links 420, 422, 424, and 426 with each of hubs 410 having an equal weight. For instance, link 420 may get 100 Mbps, link 422 may get 70 Mbps, link 424 may get 150 Mbps, and link 426 may get 80 Mbps for a total of 400 Mbps.

However, when multiple transport interfaces and/or TLOC extensions are utilized, equal weight load-balancing may result in network traffic being dropped.

FIG. 4B illustrates an example of a deployment with TLOC extension, according to some aspects of the present disclosure. In deployment 450 and compared to deployment 400, branch site 402 may include two spokes (spoke 408 and spoke 452), thus providing two transport interfaces for branch site 402. The first transport interface is provided via links 420, 422, 424, 426 and 428 (e.g., INET overlay), while the second transport interface is provided via links 454, 456, 458, and 460 (e.g., MPLS overlay).

Equal (or static) load-balancing may result in packet drops. As an example, the 400 Mbps link capacity described above may be split between the two transport interfaces in FIG. 4B (e.g., 200 Mbps on link 428 and another 200 Mbps on links 454, 546, 548, and 460).

Statis load balancing may assign 110 Mbps on link 420 and 110 Mbps on link 424 for a total of 220 Mbps on one transport interface, which is greater than the 200 Mbps link capacity. This results in an overrun of first transport interface. The overrun results in packets being dropped. In the meantime, link capacity for links 454 and 456 may each be 70 Mbps, resulting in unused link capacity that could otherwise be used for transporting network traffic on links 420 and 424 that are being dropped. In other words, links 454 and 456 remain under-utilized.

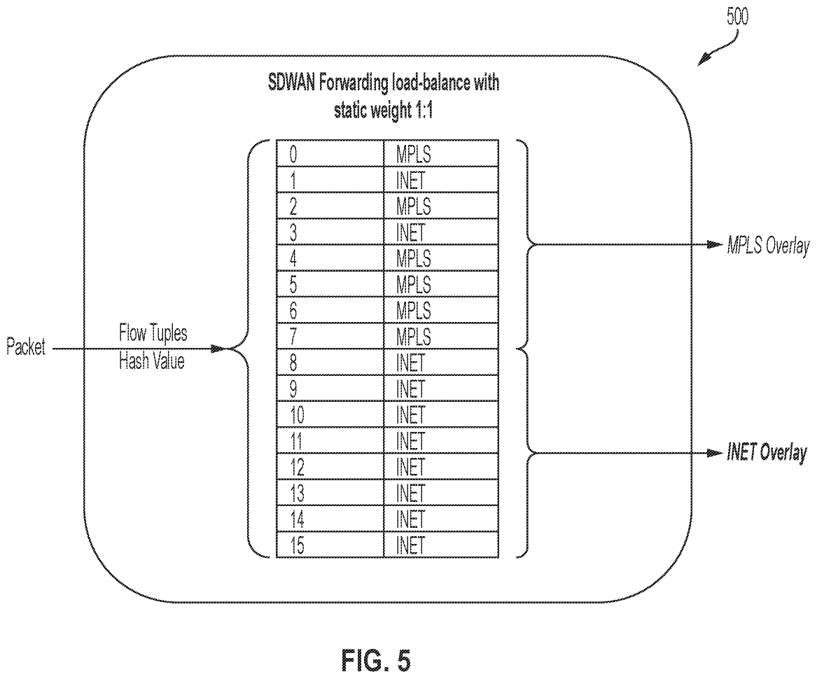

SDWAN Forwarding weighted load-balance is based on static TLOC weight configuration. FIG. 5 shows an example table for SDWAN forwarding load-balance with static weight, according to some aspects of the present disclosure. As shown in table 500, 16 hashing buckets are defined for default weights for MPLS and INET transport, based on flow tuples (source/destination IP/port, and protocol ID, and anti-polarization random seed), MPLS and INET paths are filled in with 1:1 ratio evenly, as shown.

Without dynamic weighted Load-Balance and Adaptive QoS feedback, the weight is fixed or statically configured at both remote and local TLOC interfaces, and SDWAN forwarding performs a two steps process to load-balance based on remote and local TLOCs. Without configuring the weights, traffic is dropped at the first transport interface (e.g., for hub 410-1 over INET paths) with about 46.7% WAN-LOSS drops, and the second transport interface (e.g., for hub 410-1 over MPLS paths) is not fully utilized (0% drop) with 150 Mbps transport bandwidth capacity respectively since only 100 Mbps traffic gets forwarded along this path.

LOCAL-LOSS drops over the first interface are tabulated in example table 1 below, showing the approximate 46.7% local drops when weights are statically configured according to table 500:
Hub 410-1 (cEdge1) #show platform software sdwan qos adapt history all
SDWAN OMP Session
Color: public-internet
Dest Tloc: 10.5.0.1
Dest IP: 100.64.5.10
Dest Port: 12346
Encap: IPSEC
Adaptive QoS History:

TABLE 1
TIME LOCAL-LOSS WAN-LOSS TOTAL-OFFER
THROUGHPUT ADAPT SHAPE-RATE

| | | | (pps) | (kbps) | | (kbps) |
|---|---|---|---|---|---|---|
| 2023-02-23T04:25:54 | 46.7% | 0.0% | 8192 | 50001 | UP | 50500 |
| 2023-02-23T04:24:54 | 46.2% | 1.0% | 8192 | 50499 | DOWN | 50000 |
| 2023-02-23T04:23:54 | 46.7% | 0.0% | 8192 | 50001 | UP | 50500 |
| 2023-02-23T04:22:54 | 46.7% | 0.2% | 8192 | 49999 | DOWN | 50000 |
| 2023-02-23T04:21:54 | 31.5% | 22.2% | 8192 | 64229 | DOWN | 50000 |
| 2023-02-23T04:20:54 | 14.2% | 20.2% | 8192 | 80489 | DOWN | 64230 |
| 2023-02-23T04:19:54 | 30.2% | 0.0% | 8192 | 65501 | UP | 80500 |
| 2023-02-23T04:18:54 | 46.2% | 0.0% | 8192 | 50499 | UP | 65500 |

Under-utilization over the second interface are tabulated in example table 2 below, showing 0% local and WAN drops when weights are statically configured according to table 500.
SDWAN OMP Session
Color: public-internet
Dest Tloc: 10.5.0.1
Dest IP: 176.16.5.2
Dest Port: 12386
Encap: IPSEC
Adaptive QoS History:

TABLE 2
TIME LOCAL-LOSS WAN-LOSS TOTAL-OFFER
THROUGHPUT ADAPT SHAPE-RATE

| | | | (pps) | (kbps) | (kbps) |
|---|---|---|---|---|---|
| 2023-02-23T04:25:54 | 0.0% | 0.0% | 9709 | 111942 | NOPE 200000 |
| 2023-02-23T04:24:54 | 0.0% | 0.0% | 9709 | 111930 | NOPE 200000 |
| 2023-02-23T04:23:54 | 0.0% | 0.0% | 9709 | 111834 | NOPE 200000 |

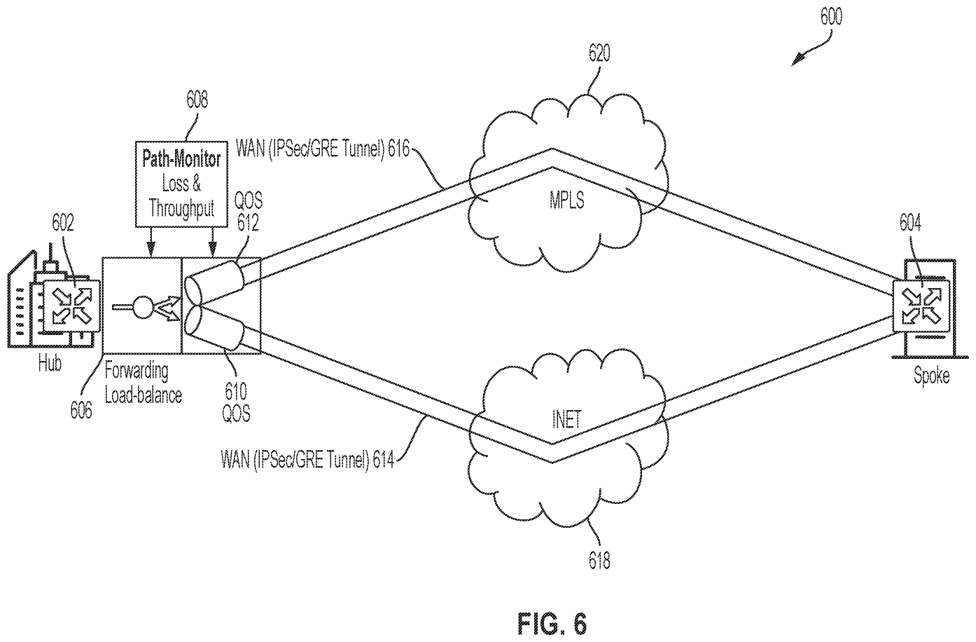

FIG. 6 illustrates a simplified deployment in which dynamically weighted load-balancing informed in part by adaptive QoS parameters may be deployed, according to some aspects of the present disclosure.

In example deployment 600 of FIG. 6, a simplified scenario of one hub 602 and one spoke 604 are considered. Hub 602 may be the same as any one of hubs 410 of FIGS. 4A and B. Spoke 604 may be the same as any one of spoke(s) 408 of FIGS. 4A-B.

FIG. 6 shows that an SDWAN's forwarding load-balance function 606 (may be referred to as a forward load-balancer 606) may utilize QoS parameters monitored by path-monitor 608 using QoS agents 610 and 612. QoS agent 610 may be installed at ingress of transport link 614 (over INET overlay 618, which can be the same as first transport interface of FIGS. 4A-B). Similarly QoS agent 612 may be installed at egress of transport link 616 (over MPLS overlay 620, which can be the same as second transport interface of FIGS. 4A-b).

QoS parameters may include, but are not limited to, traffic offering throughput, local/WAN drop ratio, and congestion state, among others.

path-monitor 608 can provide information on multiple paths bandwidth usage (bandwidth usage by links 614 and 616), traffic offering throughput, local/WAN drop ratio, and congestion state, etc., to forwarding load-balancer 606. Forwarding load-balancer 606 may use the information provided by path-monitor 608 to dynamically adjust the weight for each transport interface with proper weight. Doing so will help load-balance traffic across alternative paths with less utilization, and avoid local QoS drops.

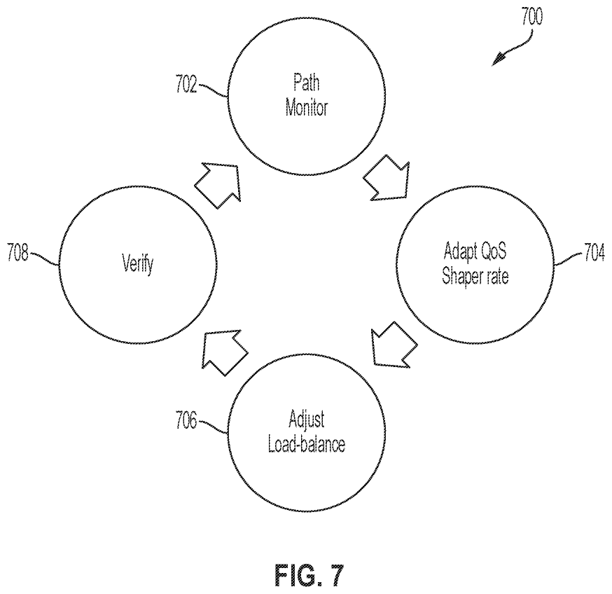

FIG. 7 visually illustrates the steps of dynamically weighted load-balancing informed in part by adaptive QoS parameters, according to some aspects of the present disclosure.

Within feedback cycle 700, at process 702, path-monitor 608 may measure network statistics including, but not limited to, SDWAN session level throughput, local/WAN drop ratio, and congestion state, etc.

At process 704 and based on the measured statistics (metrics), an SDWAN controller (e.g., a vManage), may determine a per-tunnel QoS SDWAN session level share rate (examples of per-tunnel shape rate can include the 110 Mbps, 70 Mbps, etc., as described with reference to FIGS. 4A-B). In one example, per-tunnel QoS SDWAN session level share rate may be performed as described in U.S. Pat. No. 11,563,686 filed on Dec. 15, 2020, assigned to Cisco Technology Inc., of San Jose, CA, the entire content of which is incorporated herein by reference.

Using the per-tunnel QoS SDWAN session level share rate, at process 706, the network controller may adjust SDWAN forwarding load-balance weight. In one example, the weight may be adjusted by local TLOC weight (e.g., TLOC weight (t1)=shape-rate (t1)/1000). Here, the division by 1000 is for purposes of ensuring that shape-rate unit is in Mbps.

After adjusting the forwarding load-balance weight, at process 708, the adjusted forwarding load-balance weights and tunnel metrics are monitored. Process 708 completes feedback cycle 700. In some examples, upon detecting a link overrun and/or packet drops, during process 708, processes 702, 704, and 706 may be repeated.

Tables 3 and 4 below show two non-limiting examples of weight values reflected in SDWAN TLOC forwarding hashing table to dynamically distribute and load balance traffic flows over multiple interfaces based on available bandwidth.

TABLE 3
Hub 410-1 (cEdge1) - show platform software sdwan gos adapt stats
Adaptive QoS Stats

| | DEST- | | DEST- | | | | | | SHAPE- | |
|---|---|---|---|---|---|---|---|---|---|---|
| Color | TLOC | DEST-IP | PORT | ENCAP | DEFAULT | MIN | MAX | PERD | RATE | WEIGHT |
| public- | 10.5.0.1 | 100.64.5.10 | 12346 | IPSEC | 100000 | 50000 | 200000 | 1 | 50500 | 50 |
| internet | | | | | | | | | | |
| public- | 10.5.0.1 | 176.16.5.2 | 12386 | IPSEC | 200000 | 50000 | 200000 | 1 | 200000 | 200 |
| internet | | | | | | | | | | |

TABLE 4
Hub 410-1 (cEdge1) - show platform software sdwan qos adapt stats
Adaptive QoS Stats

| | DEST- | | DEST- | | | | | | SHAPE- | |
|---|---|---|---|---|---|---|---|---|---|---|
| Color | TLOC | DEST-IP | PORT | ENCAP | DEFAULT | MIN | MAX | PERD | RATE | WEIGHT |
| public- | 10.5.0.1 | 100.64.5.10 | 12346 | IPSEC | 100000 | 50000 | 200000 | 1 | 50000 | 50 |
| internet | | | | | | | | | | |
| public- | 10.5.0.1 | 176.16.5.2 | 12386 | IPSEC | 200000 | 50000 | 200000 | 1 | 150435 | 150 |
| internet | | | | | | | | | | |

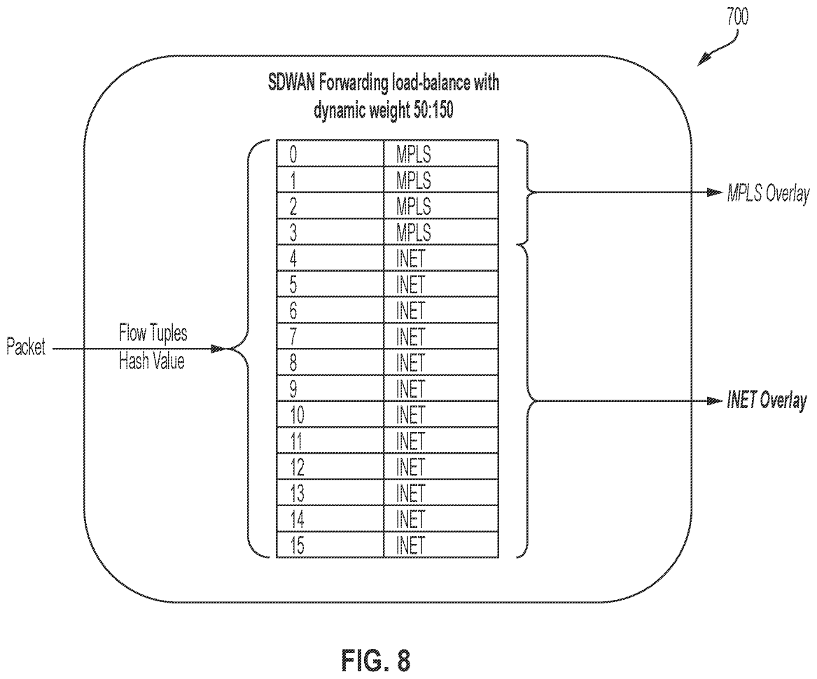

FIG. 8 illustrates an example SDWAN forwarding load-balance table with dynamic weights, according to some aspects of the present disclosure. Table 800 reflects hash table with dynamic weights according to example Table 4 above. This example dynamic load-balancing influenced by QoS parameters can result in almost no WAN-LOSS over the first and/or second transport interfaces as shown in Table 5 (relative to Table 1 above) and Table 6 (relative to Table 2 above) below respectively.

As can be seen in Table 5 (moving up Table 5), at time 04:27:54, dynamic weight adjustment is implemented and we can see that LOCAL-LOSS ratio of 46.2% drops to 3.1% and 4.1% during next two intervals as measured by path-monitor.
Hub 410-1 (cEdge1)—show platform software sdwan qos adapt history all
SDWAN OMP Session
Color: public-internet
Dest Tloc: 10.5.0.1
Dest IP: 100.64.5.10
Dest Port: 12346
Encap: IPSEC
Adaptive QoS History:

TABLE 5
TIME LOCAL-LOSS WAN-LOSS TOTAL-OFFER
THROUGHPUT ADAPT SHAPE-RATE

| | | | (pps) | (kbps) | | (kbps) |
|---|---|---|---|---|---|---|
| 2023-02-23T04:29:54 | 4.1% | 0.0% | 4519 | 50008 | UP | 50500 |
| 2023-02-23T04:28:54 | 3.1% | 1.0% | 4519 | 50506 | DOWN | 50000 |
| 2023-02-23T04:27:54 | 46.7% | 0.0% | 8192 | 50000 | UP | 50500 |
| 2023-02-23T04:26:54 | 46.2% | 1.0% | 8192 | 50499 | DOWN | 50000 |
| 2023-02-23T04:25:54 | 46.7% | 0.0% | 8192 | 50001 | UP | 50500 |
| 2023-02-23T04:24:54 | 46.2% | 1.0% | 8192 | 50499 | DOWN | 50000 |
| 2023-02-23T04:23:54 | 46.7% | 0.0% | 8192 | 50001 | UP | 50500 |
| 2023-02-23T04:22:54 | 46.7% | 0.2% | 8192 | 49999 | DOWN | 50000 |

SDWAN OMP Session
Color: public-internet
Dest Tloc: 10.5.0.1
Dest IP: 176.16.5.2
Dest Port: 12386
Encap: IPSEC
Adaptive QoS History:

TABLE 6
TIME LOCAL-LOSS WAN-LOSS TOTAL-OFFER
THROUGHPUT ADAPT SHAPE-RATE

| | | | (pps) | (kbps) | | (kbps) |
|---|---|---|---|---|---|---|
| 2023-02-23T04:29:54 | 2.1% | 0.0% | 13107 | 150438 | UP | 151939 |
| 2023-02-23T04:28:54 | 0.0% | 2.1% | 13107 | 153662 | DOWN | 150435 |
| 2023-02-23T04:27:54 | 0.0% | 0.0% | 9709 | 111942 | NOPE | 200000 |
| 2023-02-23T04:26:54 | 0.0% | 0.0% | 9709 | 111922 | NOPE | 200000 |
| 2023-02-23T04:25:54 | 0.0% | 0.0% | 9709 | 111942 | NOPE | 200000 |
| 2023-02-23T04:24:54 | 0.0% | 0.0% | 9709 | 111930 | NOPE | 200000 |
| 2023-02-23T04:23:54 | 0.0% | 0.0% | 9709 | 111834 | NOPE | 200000 |

With such dynamic weighted Load-Balance with Adaptive QoS Path-Monitor and Bandwidth Measurement, we can automate and dynamically load-balance traffic based on varied network topology and bandwidth capacity, maximize available bandwidth usage among multiple paths. This capability is especially helpful for satellite and star-link where we don't have knowledge of the available bandwidth. Also the solution would help both for Adaptive QoS downstream and upstream use-cases.

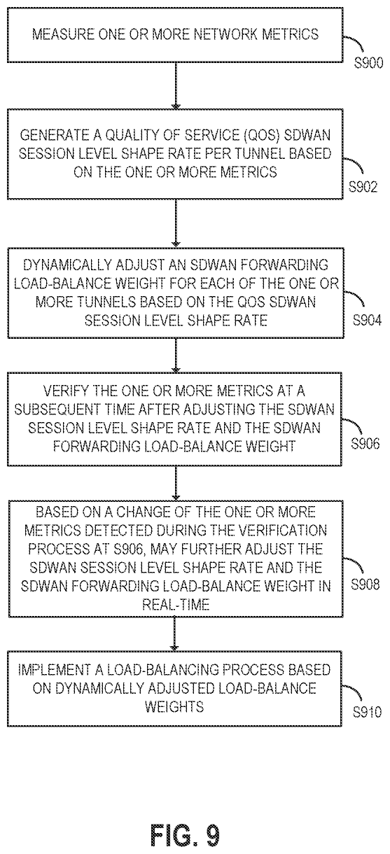

FIG. 9 illustrates an example method of dynamically weighted load-balancing informed in part by adaptive QoS parameters, according to some aspects of the present disclosure. Example process of FIG. 9 will be described from a perspective of a network controller such as network controller appliances 132, SDWAN controllers 416, etc.

At S900, a network controller may determine one or more metrics. Such metrics can include QoS related metrics measured at example process 702 described above with reference to FIG. 7. Such metrics may be measured based on one or more Software-defined Wide Area Network (SDWAN) session level throughput and SDWAN session loss through one or more tunnels, etc.

In some examples, a path-monitor service (e.g., path-monitor 608), controlled by the network controller, may leverage multiple tunnel bandwidth usage and local WAN loss ratio to provide the one or more metrics. In some examples, the path monitor-service may monitor QoS status for each of the one or more tunnels by monitoring traffic throughput, Local/WAN drop ratio, and congestion state.

At S902, the network controller may generate a Quality of Service (QoS) SDWAN session level shape rate per tunnel based on the one or more metrics. This may be performed as described above with reference to example process 704 of FIG. 7.

At S904, the network controller may dynamically adjust an SDWAN forwarding load-balance weight for each of the one or more tunnels based on the QoS SDWAN session level shape rate. This may be performed according to example process 706 of FIG. 7.

At S906, the network controller may verify the one or more metrics at a subsequent time after adjusting the SDWAN session level shape rate and the SDWAN forwarding load-balance weight. This may be performed according to example process 708 of FIG. 7.

At S908, the network controller, based on a change of the one or more metrics detected during the verification process at S906, may further adjust the SDWAN session level shape rate and the SDWAN forwarding load-balance weight in real-time.

At S910, the network controller may implement a load-balancing process based on dynamically adjusted load-balance weights as determined per S904 and/or S908. In some examples, the load-balancing process may include (1) determining that a first transport link has local Wide Area Network (WAN) QoS congestion based on the one or more metrics monitored by a path monitor service, the first transport link having a first weight, (2) determining that a second transport link is underutilized based on the one or more metrics monitored by the path monitor service, the second transport link having a second weight, (3) dynamically adjusting the SDWAN forwarding load-balance weight for the first transport link and the second transport link by modifying the first weight and the second weight in accordance with the one or more metrics monitored by the path monitor service, and (4) rerouting traffic from the first transport link to the second transport link based on QoS requirements.

In another example, the load-balancing process may include (1) determining, at a first time, a first utilization of a first transport link and a second utilization of a second transport link based on the one or more metrics monitored by a path monitor service, wherein at least one of the first transport link and the second transport link is a dynamic link with variable transport bandwidth capacity, (2) dynamically assigning a first weight for the first transport link and a second weight for the second transport link, (3) determining, at a second time, that a transport bandwidth capacity of the second transport link has increased, (4) based on the determination, dynamically increasing the second weight and decreasing the first weight, and (5) routing traffic along the first transport link in accordance with the first weight and the second transport link in accordance with the second weight.

In some examples, dynamically adjusting the load-balance weights at S904 and/or S908, includes adjusting the SDWAN forwarding load-balance weight for each of the one or more tunnels by a Transport Locator (TLOC) Session weight value, the TLOC session weight value based on the one or more metrics describing measured bandwidth capacity.

In some examples, the TLOC session weight value may be forwarded to a SDWAN TLOC forwarding hashing table which dynamically distributes and load balances traffic flows over multiple tunnels based on available bandwidth.

FIG. 10 shows an example of computing system, according to some aspects of the present disclosure. As shown, example computing system 1000 can be used as any of the components of systems and network architectures described above with reference to FIGS. 1-9. Example computing system 1000 or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including system memory 1015, read-only memory (ROM) 1020, and random access memory (RAM) 1025 to processor 1010. Computing system 1000 can include a cache of high-speed memory 1012 connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. There is no restriction on operating on any particular hardware arrangement, and therefore the basic features here may easily be substituted for improved hardware or firmware arrangements as they are developed.

Storage device 1030 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
determining one or more metrics based on one or more Software-defined Wide Area Network (SDWAN) session level throughput and SDWAN session loss through one or more tunnels;
generating a Quality of Service (QoS) SDWAN session level shape rate per tunnel based on the one or more metrics; and
dynamically adjusting an SDWAN forwarding load-balance weight for each of the one or more tunnels based on the QoS SDWAN session level shape rate.

2. The method of claim 1, further comprising:
verifying the one or more metrics at a subsequent time after adjusting the SDWAN session level shape rate and the SDWAN forwarding load-balance weight; and
based on a change of the one or more metrics, further adjusting the SDWAN session level shape rate and the SDWAN forwarding load-balance weight in real-time.

3. The method of claim 1, further comprising:
determining that a first transport link has local Wide Area Network (WAN) QoS congestion based on the one or more metrics monitored by a path monitor service, the first transport link having a first weight;
determining that a second transport link is underutilized based on the one or more metrics monitored by the path monitor service, the second transport link having a second weight;
dynamically adjusting the SDWAN forwarding load-balance weight for the first transport link and the second transport link by modifying the first weight and the second weight in accordance with the one or more metrics monitored by the path monitor service; and
rerouting traffic from the first transport link to the second transport link based on QoS requirements.

4. The method of claim 1, further comprising:
determining, at a first time, a first utilization of a first transport link and a second utilization of a second transport link based on the one or more metrics monitored by a path monitor service, wherein at least one of the first transport link and the second transport link is a dynamic link with variable transport bandwidth capacity;
dynamically assigning a first weight for the first transport link and a second weight for the second transport link;
determining, at a second time, that a transport bandwidth capacity of the second transport link has increased;
based on the determination, dynamically increasing the second weight and decreasing the first weight; and
routing traffic along the first transport link in accordance with the first weight and the second transport link in accordance with the second weight.

5. The method of claim 1, further comprising:
adjusting the SDWAN forwarding load-balance weight for each of the one or more tunnels by a Transport Locator (TLOC) Session weight value, the TLOC session weight value based on the one or more metrics describing measured bandwidth capacity; and
forwarding the TLOC session weight value to a SDWAN TLOC forwarding hashing table which dynamically distributes and load balances traffic flows over multiple tunnels based on available bandwidth.

6. The method of claim 1, wherein a path monitor service leverages multiple tunnel bandwidth usage and local WAN loss ratio.

7. The method of claim 1, wherein a path monitor service monitors QoS status for each of the one or more tunnels by monitoring traffic throughput, Local/WAN drop ratio, and congestion state.

8. A network controller comprising:
one or more memories having computer-readable instructions stored therein; and
one or more processors configured to execute the computer-readable instructions to:
determine one or more metrics based on one or more Software-defined Wide Area Network (SDWAN) session level throughput and SDWAN session loss through one or more tunnels;
generate a Quality of Service (QoS) SDWAN session level shape rate per tunnel based on the one or more metrics; and
dynamically adjust an SDWAN forwarding load-balance weight for each of the one or more tunnels based on the QoS SDWAN session level shape rate.

9. The network controller of claim 8, wherein the one or more processors are further configured to execute the computer-readable instructions to:
verify the one or more metrics at a subsequent time after adjusting the SDWAN session level shape rate and the SDWAN forwarding load-balance weight; and
based on a change of the one or more metrics, further adjust the SDWAN session level shape rate and the SDWAN forwarding load-balance weight in real-time.

10. The network controller of claim 8, wherein the one or more processors are further configured to execute the computer-readable instructions to:
determine that a first transport link has local Wide Area Network (WAN) QoS congestion based on the one or more metrics monitored by a path monitor service, the first transport link having a first weight;
determine that a second transport link is underutilized based on the one or more metrics monitored by the path monitor service, the second transport link having a second weight;
dynamically adjust the SDWAN forwarding load-balance weight for the first transport link and the second transport link by modifying the first weight and the second weight in accordance with the one or more metrics monitored by the path monitor service; and
reroute traffic from the first transport link to the second transport link based on QoS requirements.

11. The network controller of claim 8, wherein the one or more processors are further configured to execute the computer-readable instructions to:
determine, at a first time, a first utilization of a first transport link and a second utilization of a second transport link based on the one or more metrics monitored by a path monitor service, wherein at least one of the first transport link and the second transport link is a dynamic link with variable transport bandwidth capacity;
dynamically assign a first weight for the first transport link and a second weight for the second transport link;
determine, at a second time, that a transport bandwidth capacity of the second transport link has increased;
based on the determination, dynamically increase the second weight and decreasing the first weight; and
route traffic along the first transport link in accordance with the first weight and the second transport link in accordance with the second weight.

12. The network controller of claim 8, wherein the one or more processors are further configured to execute the computer-readable instructions to:
adjust the SDWAN forwarding load-balance weight for each of the one or more tunnels by a Transport Locator (TLOC) Session weight value, the TLOC session weight value based on the one or more metrics describing measured bandwidth capacity; and
forward the TLOC session weight value to a SDWAN TLOC forwarding hashing table which dynamically distributes and load balances traffic flows over multiple tunnels based on available bandwidth.

13. The network controller of claim 8, wherein a path monitor service leverages multiple tunnel bandwidth usage and local WAN loss ratio.

14. The network controller of claim 8, wherein a path monitor service monitors QoS status for each of the one or more tunnels by monitoring traffic throughput, Local/WAN drop ratio, and congestion state.

15. One or more non-transitory computer readable media comprising computer-readable instructions, which when executed by a network controller, cause the network controller to:
determine one or more metrics based on one or more Software-defined Wide Area Network (SDWAN) session level throughput and SDWAN session loss through one or more tunnels;
generate a Quality of Service (QoS) SDWAN session level shape rate per tunnel based on the one or more metrics; and
dynamically adjust an SDWAN forwarding load-balance weight for each of the one or more tunnels based on the QoS SDWAN session level shape rate.

16. The one or more non-transitory computer readable media of claim 15, wherein the execution of the computer-readable instructions further cause the network controller to:
verify the one or more metrics at a subsequent time after adjusting the SDWAN session level shape rate and the SDWAN forwarding load-balance weight; and
based on a change of the one or more metrics, further adjust the SDWAN session level shape rate and the SDWAN forwarding load-balance weight in real-time.

17. The one or more non-transitory computer readable media of claim 15, wherein the execution of the computer-readable instructions further cause the network controller to:
determine that a first transport link has local Wide Area Network (WAN) QoS congestion based on the one or more metrics monitored by a path monitor service, the first transport link having a first weight;
determine that a second transport link is underutilized based on the one or more metrics monitored by the path monitor service, the second transport link having a second weight;
dynamically adjust the SDWAN forwarding load-balance weight for the first transport link and the second transport link by modifying the first weight and the second weight in accordance with the one or more metrics monitored by the path monitor service; and
reroute traffic from the first transport link to the second transport link based on QoS requirements.

18. The one or more non-transitory computer readable media of claim 15, wherein the execution of the computer-readable instructions further cause the network controller to:
determine, at a first time, a first utilization of a first transport link and a second utilization of a second transport link based on the one or more metrics monitored by a path monitor service, wherein at least one of the first transport link and the second transport link is a dynamic link with variable transport bandwidth capacity;
dynamically assign a first weight for the first transport link and a second weight for the second transport link;
determine, at a second time, that a transport bandwidth capacity of the second transport link has increased;
based on the determination, dynamically increase the second weight and decreasing the first weight; and
route traffic along the first transport link in accordance with the first weight and the second transport link in accordance with the second weight.

19. The one or more non-transitory computer readable media of claim 15, wherein the execution of the computer-readable instructions further cause the network controller to:
adjust the SDWAN forwarding load-balance weight for each of the one or more tunnels by a Transport Locator (TLOC) Session weight value, the TLOC session weight value based on the one or more metrics describing measured bandwidth capacity; and
forward the TLOC session weight value to a SDWAN TLOC forwarding hashing table which dynamically distributes and load balances traffic flows over multiple tunnels based on available bandwidth.

20. The one or more non-transitory computer readable media of claim 15, wherein a path monitor service leverages multiple tunnel bandwidth usage and local WAN loss ratio.
